(19) United States
(12) Patent Application Publication
(10) Pub. No.: US 2022/0129774 A1
(43) Pub. Date: Apr. 28, 2022

(54) INFORMATION PROCESSING SYSTEM AND INFORMATION PROCESSING METHOD

(71) Applicant: HITACHI, LTD., Tokyo (JP)

(72) Inventors: Naoaki YOKOI, Tokyo (JP); Haruka YAMADA, Tokyo (JP); Masashi EGI, Tokyo (JP)

(73) Assignee: HITACHI, LTD., Tokyo (JP)

(21) Appl. No.: 17/469,542

(22) Filed: Sep. 8, 2021

(30) Foreign Application Priority Data
Oct. 27, 2020 (JP) 2020-180026

(51) Int. Cl. G06N 5/04; G06N 20/00

(52) U.S. Cl. CPC G06N 5/045; G06N 20/00

(57) ABSTRACT

An information processing system includes a predictor, a contribution calculator, and a supplemental base generator. The system accesses databases that store relevance between feature variables in case data and a contribution of a feature variable in the case data to a result of prediction. The contribution calculator calculates the contribution of each of the feature variables in the evaluation target data to the output of the predictor, and outputs the calculated contributions and the acquired evaluation target data. The supplemental reason generator extracts a group of data proximate to the value and the contribution of a first feature variable, identifies a second feature variable relevant to the first feature variable, generates supplemental reason data based on a distribution of the proximate data group within a distribution of the second feature variable by use of the case data, and outputs the generated supplemental reason data.

### BACKGROUND OF THE INVENTION

### 1. Field of the Invention

The present invention relates to a technology for visualizing the reason for decision making by artificial intelligence.

### 2. Description of the Related Art

Artificial Intelligence (AI), which has been used for such purposes as prediction and classification, has made significant progress in recent years. AI is a sort of function approximator that can handle large amounts of data at high speed compared with humans. However, the content of AI models created by machine learning (e.g., deep learning neural network or deep neural network (DNN) models) is inordinately complicated and basically constitutes a black box. It is thus difficult for users to know the reason for the prediction and classification performed by AI.

In view of this, the concept of Explainable AI (XAI) has been advocated. XAI refers to a whole group of technologies not just for analyzing the cases where the processes leading to the results of prediction and classification performed by AI are explainable but also analyzing the reason for the results of prediction and classification by AI constituting a black box. Representative technologies of XAI include Local Interpretable Model-agnostic explanations (LIME) and, as its extension, SHapely Additive exPlanations (SHAP) (see S. M. Lundberg and S. Lee, “A Unified Approach to Interpreting Model Predictions, NIPS 2017”).

There are also known techniques for analyzing the relation between objective variables and explanatory variables with a view to identifying those explanatory variables that strongly affect changes in values of the objective variables. The explanatory variables in analogous relations to each other are then grouped in such a manner that their time-series data belong to the same group. From each of the groups, the time-series data of the explanatory variable representative of the group is extracted in order to analyze the data being represented by the explanatory variable (see WO2018/096683A1).

There is also known a methodology of searching for a causal relation between variables, based on, for example, data distribution, such as for a relation in which changing a variable A leads to a change in a variable B, the variable A being the cause and the variable B being the effect (i.e., a search for the causal direction from A to B and the magnitude of the A-to-B direction) (see Shohei Shimizu, et. al, “A Linear Non-Gaussian Acyclic Model for Causal Discovery,” Journal of Machine Learning Research 7 (2006) 2003-2030)).

### SUMMARY OF THE INVENTION

With LIME and SHAP, if a change in a particular input data item (feature variable) inverts or significantly varies the result output from AI, then that item is estimated to have a “high degree of importance in decision making.”

However, in the existing examples mentioned above, there is a possibility that XAI may present an explanation incongruous with the findings in the field. This can detract from the reliability of the model involved. Such an eventuality can occur in cases where a machine learning model is trained with emphasis on the variables that have a high degree of correlation with the variable considered inherently important in domain knowledge and that are in spurious correlation with objective variables.

The inventors studied the cause of that eventuality and came to the view that, in a case where there are multiple variables highly relevant to the training data, a highly sophisticated learning model tends to learn by paying attention to as few variables as possible. The “highly relevant variables” are variables such that one variable permits estimation of the value of another variable, such as highly correlated variables.

In view of the above, although a given variable may be an important variable from the viewpoint of the field (e.g., time slot), the model may learn by paying attention to another highly relevant variable instead of the variable deemed inherently important (i.e., humidity is taken note of in place of time slot). The contribution of the variable considered inherently important (time slot) is thus absorbed by another highly relevant variable (humidity). This causes the inherently important variable to be underestimated while the contribution of an apparently irrelevant variable (humidity) is raised. That is, the variable considered irrelevant from the viewpoint of the field can be overestimated.

It is therefore an object of the present invention to provide an XAI technology for easily ensuring consistency with the findings in the field.

According to one preferred aspect of the present invention, there is provided an information processing system including a predictor, a contribution calculation section, and a supplemental reason generation section, the system being capable of accessing a feature variable relevance storage database that stores relevance between feature variables in case data and a case data contribution storage database that stores a contribution of a feature variable in the case data to a result of prediction by the predictor. The contribution calculation section inputs the predictor and evaluation target data as input to the predictor, calculates a contribution of each of the feature variables in the evaluation target data to output of the predictor, and outputs the calculated contributions and the acquired evaluation target data as contribution data. The supplemental reason generation section inputs the contribution data, extracts a group of data proximate to a value and a contribution of a first feature variable from the case data contribution storage database, identifies a second feature variable relevant to the first feature variable from the feature variable relevance storage database, generates supplemental reason data based on a distribution of the proximate data group within a distribution of the second feature variable by use of data in the case data contribution storage database, and outputs the generated supplemental reason data.

According to another preferred aspect of the present invention, there is provided an information processing method for generating supplemental information regarding a result of prediction output by a predictor upon receiving input of evaluation target data, the predictor having been trained by use of training data. The information processing method uses a feature variable relevance storage database that stores relevance between feature variables in the training data and a case data contribution storage database that stores a contribution of a feature variable in the training data to the result of prediction by the predictor. The method includes a first step of extracting a group of data proximate to a value and a contribution of a first feature variable from the case data contribution storage database; a second step of identifying a second feature variable relevant to the first feature variable from the feature variable relevance storage database; and a third step of generating information based on a distribution of the proximate data group within a distribution of the second feature variable by use of the data in the case data contribution storage database.

The invention thus provides an XAI technology for easily ensuring consistency with the findings in the field.

### BRIEF DESCRIPTION OF THE DRAWINGS

FIG. 1 is a block diagram depicting an example of an overall configuration of a computer system as an embodiment of the present invention;

FIG. 2 is a block diagram depicting an example of a hardware configuration of a computer;

FIG. 3 is a tabular view listing an example of case data;

FIG. 4 is a flowchart depicting an example of processing performed by a relevance calculation section;

FIG. 5 is a tabular view depicting an example of data in an inter-feature-variable relevance storage section;

FIG. 6 is a flowchart depicting an example of processing performed by a contribution calculation section on case data information;

FIG. 7 is a tabular view depicting an example of data in a case data contribution storage section;

FIG. 8 is a flowchart depicting an example of the flow of processing (preparations) performed by the computer system;

FIG. 9 is a flowchart depicting an example of the flow of processing (generation of supplemental information) performed by the computer system;

FIG. 10 is a tabular view listing an example of evaluation target data;

FIG. 11 is a tabular view listing an example of prediction result data;

FIG. 12 is a flowchart depicting an example of processing performed by the contribution calculation section on the evaluation target data;

FIG. 13 is a tabular view listing an example of contribution data;

FIG. 14 is a conceptual diagram depicting an overview of processing by one embodiment;

FIG. 15 is a flowchart depicting an example of processing performed by a supplemental reason generation section;

FIG. 16 is a tabular view listing an example of supplemental reason data;

FIG. 17 is an illustration depicting an example of a preliminary information registration screen;

FIG. 18 is an illustration depicting an example of an evaluation target data input screen;

FIG. 19 is an illustration depicting an example of a prediction result verification screen;

FIG. 20 is an illustration depicting an example of screen display indicating a supplemental reason; and

FIG. 21 is an illustration depicting an example of screen display indicating other supplemental bases.

### DESCRIPTION OF THE PREFERRED EMBODIMENTS

Some preferred embodiments of the present invention are described below. It is to be noted that the present invention should not be limited to the embodiments to be discussed below when interpreted. It will be understood by those skilled in the art that specific structures and configurations of the embodiments may be modified or altered within the sprit and scope of the present invention.

In the configurations of the embodiments to be described below, the parts having identical or similar functions are designated by the same reference signs across different drawings, and the explanations of such parts may be omitted where redundant.

In the case where there are multiple elements having identical or similar functions, these elements may be designated by the same reference signs furnished with different subscripts when described. However, where there is no need to distinguish between such multiple elements, the subscripts may be omitted from the description.

In this specification, the ordinal notations such as “first,” “second,” and “third” are provided to identify constituent elements and do not necessarily limit or determine the number, sequence, or details of these constituent elements. Also, the numeral for identifying a constituent element is used in each context; the numeral used in one context may or may not designate the same element in another context. Further, a constituent element identified by a given numeral may include a function or functions of another constituent element identified by another numeral.

In the drawings and elsewhere, the position, size, shape, and range of each configuration are provided to facilitate the understanding of the present invention and may not represent the position, size, shape, or range of the actual configuration. Thus, the present invention is not necessarily limited by the positions, sizes, shapes, or ranges disclosed in the drawings and elsewhere.

The publications, patents, and patent applications cited in this specification constitute part of the description of the present specification.

The constituent element represented in a singular form in this specification also includes its plural form unless otherwise specified explicitly in the context.

The embodiments below demonstrate examples in which, when XAI outputs, as a reason for model-based decision making, a contribution of an apparently irrelevant variable to the result of the decision, field personnel unfamiliar with AI technology are provided with information for supporting the interpretation and understanding of the reason of the decision making.

In one embodiment, given a feature variable A as the reason for decision making, and given the combination of its value in test data with the ratio of its contribution to model-based decision making, past case data indicative of similar trends is extracted from a database. From statistical information regarding the extracted range of data, supplemental information for interpreting the reason for the decision made is generated. As the statistical information, a range of values that can be taken by a different variable B highly relevant to the variable A is used, for example.

### First Embodiment

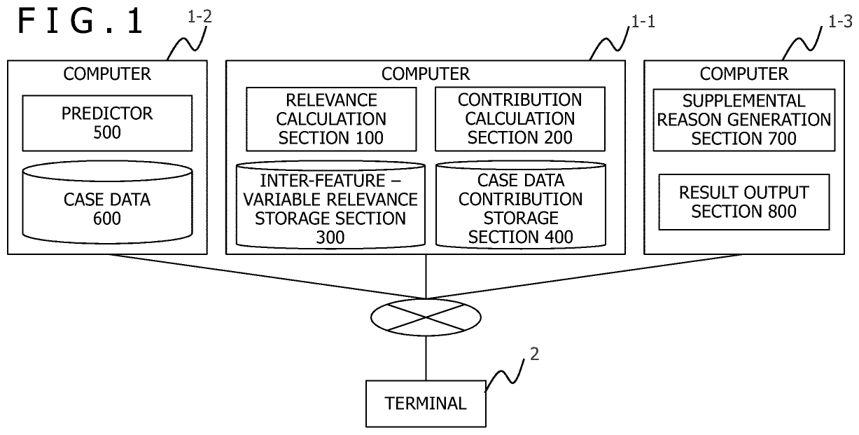

FIG. 1 is a functional block diagram depicting an example of an overall configuration of a computer system as an embodiment of the present invention. This system generates supplemental information regarding the reason of decision making by a machine learning model.

The computer system of the embodiment includes one or more computers 1. Although FIG. 1 depicts three computers 1-1 through 1-3 in use, the number of computers may be varied as desired as long as their components can exchange data therebetween.

The computer 1 includes a relevance calculation section 100, a contribution calculation section 200, a predictor 500, a supplemental reason generation section 700, and a result output section 800 as functional blocks for carrying out processing. Also included are an inter-feature-variable relevance storage section 300, a case data contribution storage section 400, and case data 600 as sets of data or databases (DB). A terminal 2 is further provided to control the functional blocks and to access the data.

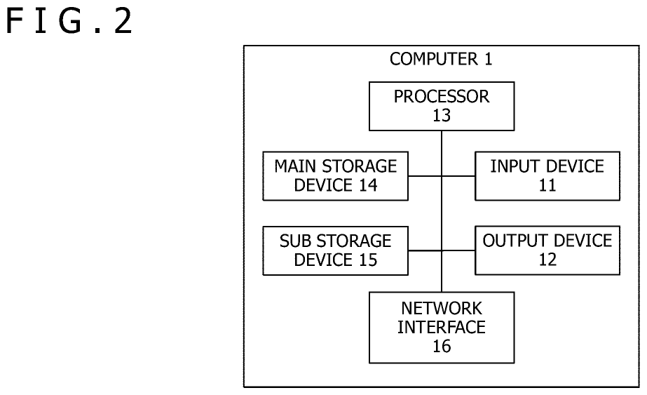

FIG. 2 is a block diagram depicting an example of a hardware configuration of the computer 1. An ordinary server may be used as the computer 1. As with ordinary servers, the computer 1 includes an input device 11, an output device 12, a processor 13, a main storage device 14, a sub storage device 15, and a network interface 16. The terminal 2 may also be configured basically the same as the computer 1.

A keyboard, a mouse, and/or a similar device may be used as the input device 11. A printer, an image display, and/or a similar device may be used as the output device 12. Any one of diverse central processing units (CPU) may be used as the processor 13. A magnetic disk drive or a similar device may be used as the main storage device 14. Any one of diverse semiconductor memories may be used as the sub storage device 15. The network interface 16 permits wired or wireless communication over networks in accordance with various protocols. These structures may be implemented using known technology and thus will not be discussed further.

In the present embodiment, the inter-feature-variable relevance storage section 300, the case data contribution storage section 400, and the case data 600 are placed in the sub storage device 15. The relevance calculation section 100, the contribution calculation section 200, the predictor 500, the supplemental reason generation section 700, and the result output section 800 are implemented by the processor 13 loading and executing relevant software stored in the sub storage device 15 in coordination with other hardware.

In the present embodiment, it is to be noted that the functions equivalent to those implemented by software may also be implemented by hardware such as the Field Programmable Gate Array (FPGA) or Application Specific Integrated Circuit (ASIC). The above configuration may be constituted by a single computer 1. Alternatively, some or all of the input device 11, the output device 12, the processor 13, the main storage device 14, the sub storage device 15, and the network interface 16 may be configured using other computers connected over networks. For example, the inter-feature-variable relevance storage section 300, the case data contribution storage section 400, and the case data 600 may be disposed remotely and include an accessible network interface 16.

### <Predictor and Case Data>

In FIG. 1, the computer 1-2 includes the predictor 500 as AI including a machine learning model and the case data 600 as training data for training the predictor 500. Generally, the training data includes problems and their correct answers. The correct answers may be given at personal discretion.

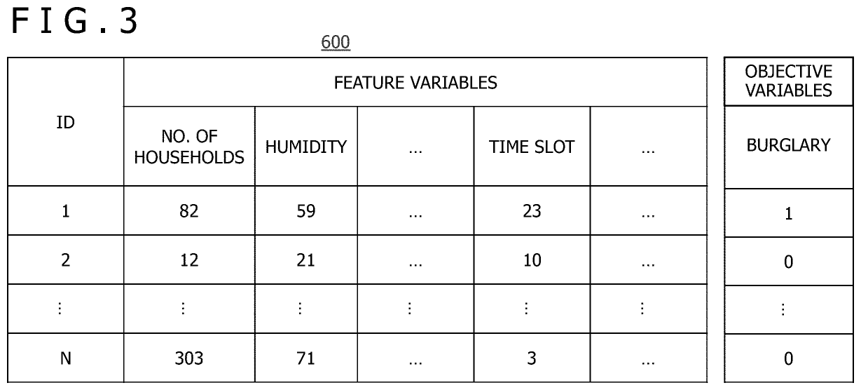

FIG. 3 is a tabular view listing an example of the case data 600. The data on the occurrence or non-occurrence of burglary is indicated as an example. Listed for each data ID are feature variables such as the number of households, humidity (%), and time slot (h), as well as the occurrence or non-occurrence of burglary, all constituting parameters. Given the case data 600 as the training data and given the feature variables such as humidity (%) and time slot (h), for example, the predictor 500 for predicting the incidence (%) of burglary may be configured in supervised learning. In this case, the feature variables such as humidity (%) and time slot (h) are explanatory variables, and the occurrence or non-occurrence of burglary is an objective variable. In the case of the training data, the explanatory variables represent problems, and the objective variables correspond to the correct answers. The configuration of, and the training method for, the predictor 500 may be devised using known technology and thus will not be discussed further. In the present specification, the case data 600 for training the predictor 500 is referred to as the “training data.”

### <Relevance Calculation Section and Inter-Feature-Variable Relevance Storage Section>

In FIG. 1, the computer 1-1 includes the relevance calculation section 100 and the inter-feature-variable relevance storage section 300. The relevance calculation section 100 calculates the relevance between feature variables by using the training data.

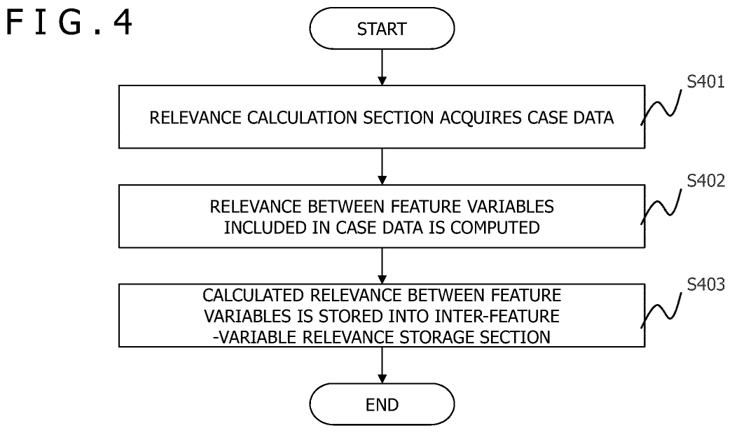

FIG. 4 depicts a flow of processing performed by the relevance calculation section 100. In step S401, the relevance calculation section 100 acquires the case data 600. In step S402, the relevance calculation section 100 calculates the relevance between the feature variables included in the case data 600. For example, correlation coefficients are used as indexes for evaluation of the relevance. It is to be noted, however, that the correlation coefficients may be used only for evaluating linear relevance. In an alternative method, a suitable regression formula may be acquired, and a degree of matching of the quantities with the regression formula may be evaluated. These processes may be performed using known technology and thus will not be discussed further. In step S403, the calculated relevance between the feature variables is stored into the inter-feature-variable relevance storage section 300.

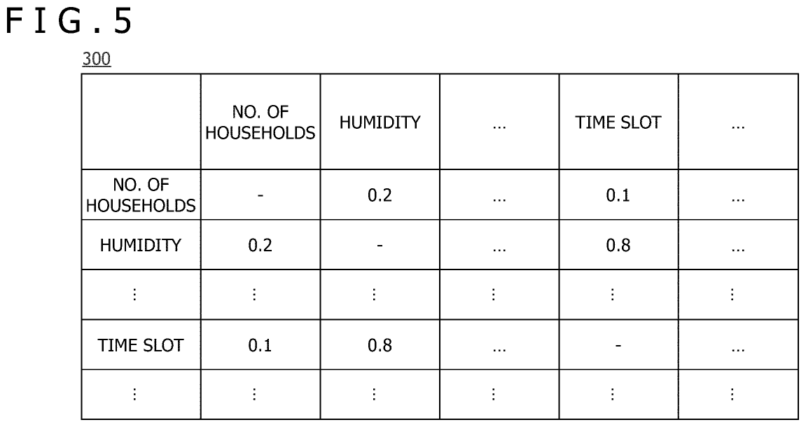

FIG. 5 is a tabular view depicting an example of inter-feature-variable relevance data stored in the inter-feature-variable relevance storage section 300. The view lists recorded degrees of relevance between the feature variables in the case data 600 depicted in FIG. 3. The values range from −1 to +1. The closer the value is to +1, the higher the relevance. A negative value represents inverse correlation.

### <Contribution Calculation Section and Case Data Contribution Storage Section>

In FIG. 1, the computer 1-1 includes the contribution calculation section 200 and the case data contribution storage section 400. The contribution calculation section 200 calculates the contribution of each feature variable to the result of decision making by the predictor 500 using the training data.

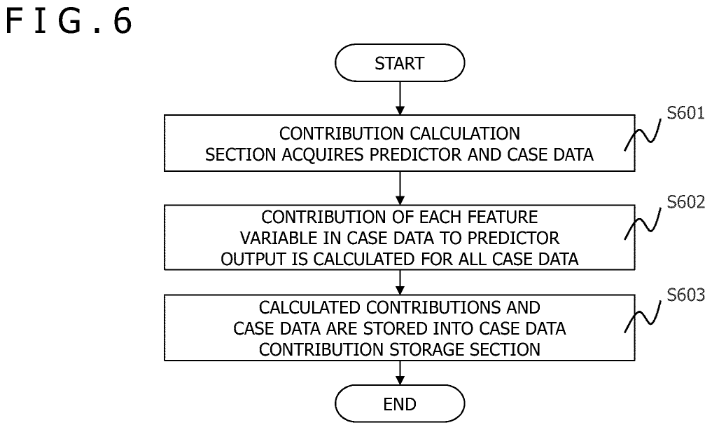

FIG. 6 is a flowchart depicting a flow of processing performed by the contribution calculation section 200 on the case data 600. In step S601, the contribution calculation section 200 acquires the predictor 500 and the case data 600. In step S602, the contribution calculation section 200 calculates the contribution of each feature variable in the case data 600 to the output of the predictor 500 for all case data. The contributions may be calculated using known technology such as the above-mentioned LIME or SHAP. With SHAP, for example, the predicted values of the predictor 500 may be uniquely factorized through the sum of the contributions of the feature variables involved. This permits acquisition of the contribution of each feature variable at the time of predicted value determination (S. M. Lundberg and S. Lee, “A Unified Approach to Interpreting Model Predictions, NIPS 2017”). Specific methods of calculation may be provided by known technology and thus will not be discussed further. In step S603, the calculated contributions of the feature variables are stored into the case data contribution storage section 400.

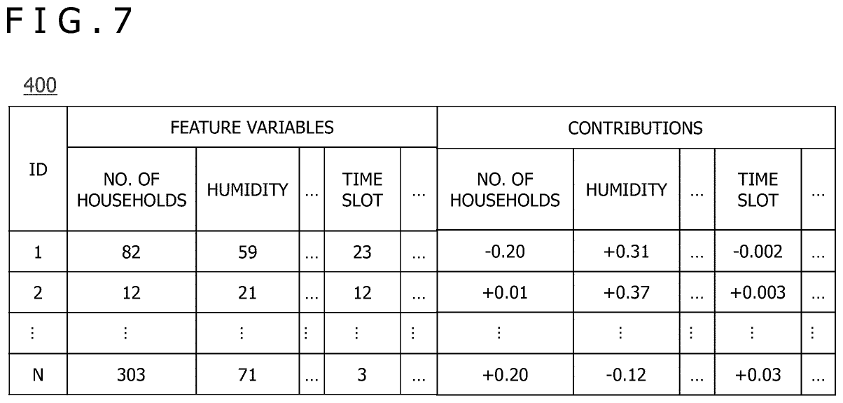

FIG. 7 is a tabular view depicting an example of case data contribution data stored in the case data contribution storage section 400. The contribution of each feature variable to the result of decision making by the predictor 500 is stored in this section. For example, given the data identified by ID “1,” the contribution of the number of households is “−0.20,” the contribution of humidity is “+0.31,” and the contribution of time slot is “−0.002.” The sum of the contributions constitutes a predicted value (e.g., incidence of burglary) given by the predictor 500. In this case, a positive contribution and a negative contribution signify an increase and a decrease in the probability of incidence, respectively.

Although the training data itself is assumed to be used as the case data in the above processing, other suitable data statistically equivalent to the training data may be used instead.

### <Supplemental Reason Generation Section and Result Output Section>

In FIG. 1, the computer 1-3 includes the supplemental reason generation section 700 and the result output section 800. The functions of these sections will be discussed later in detail.

### <Processing by the Computer System (Preparations)>

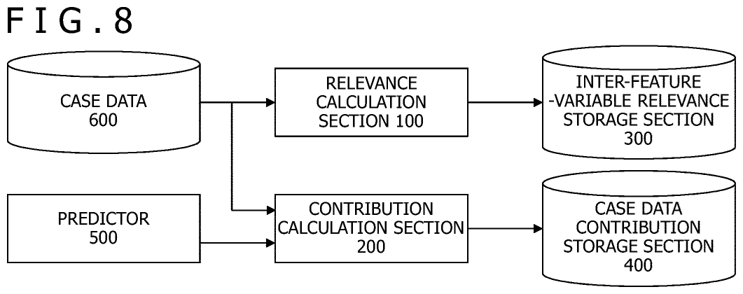

FIG. 8 is a flowchart depicting an example of the flow of processing (preparations) performed by the computer system in FIG. 1. It is assumed that the predictor 500 has already been trained using the case data 600 as the training data.

The relevance calculation section 100 calculates inter-feature-variable relevance data from the case data 600 and stores the calculated data into the inter-feature-variable relevance storage section 300 as a DB (see FIG. 5). This process may be achieved by separately creating the DB beforehand. The DB may alternatively be generated in a suitably timed manner before or during operation in response to instructions from the supplemental base generation section 700 or from the terminal 2.

The contribution calculation section 200 calculates contribution data from the case data 600 and from the predictor 500, and stores the calculated data as a DB into the case data contribution storage section 400 (see FIG. 7). This process may be accomplished by separately creating the DB in advance. The DB may alternatively be generated in a suitably timed manner before or during operation in response to instructions from the supplemental base generation section 700 or from the terminal 2.

### <Processing by the Computer System (Supplemental Information Generation Process During Operation)>

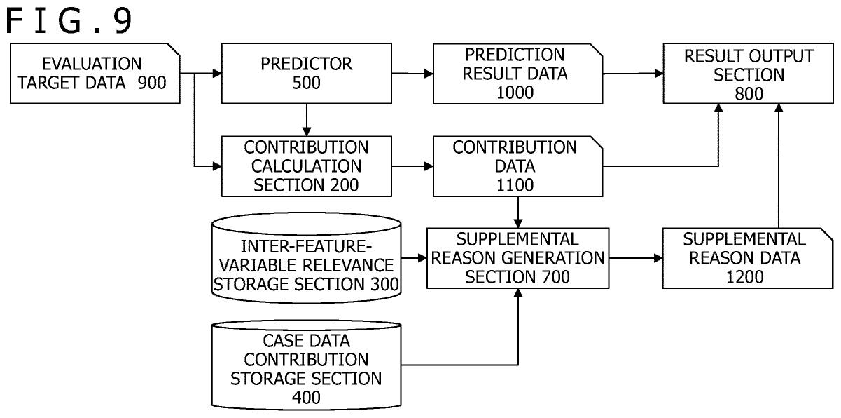

FIG. 9 is a flowchart explanatory of processing performed by the computer system of the embodiment to generate supplemental information regarding the reason for the result of prediction executed on the reason of evaluation target data.

Generally, the prediction by the predictor 500 involves inputting evaluation target data 900 as explanatory variables and outputting prediction result data 1000 as objective variables.

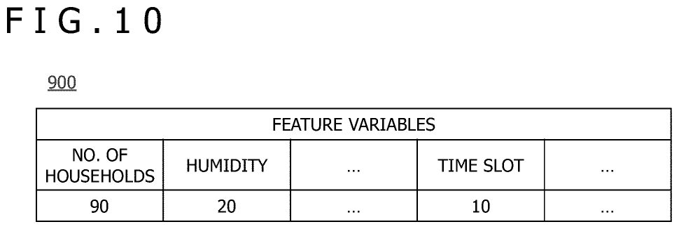

FIG. 10 is a tabular view listing an example of the evaluation target data 900. This is data that can be input to the predictor 500. For example, the data has the same feature variables as those of the explanatory variables (feature variables) in the case data 600.

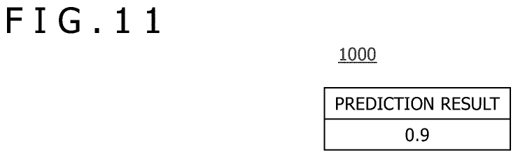

FIG. 11 is a tabular view listing an example of the prediction result data 1000. This is data that is output from the predictor 500. For example, the data may indicate the probability predicted (e.g., probability of incidence of burglary) for an objective variable (e.g., occurrence or non-occurrence of burglary) in the case data 600.

Here, the predictor 500 is a black box that outputs the prediction result data 1000 solely as a result of prediction. It is thus difficult for the user to get hold of the reason for the decision made. As discussed above, LIME and SHAP demonstrate the contribution of each item (feature variable) to the result of prediction. This helps understanding the reason for decision making by the predictor.

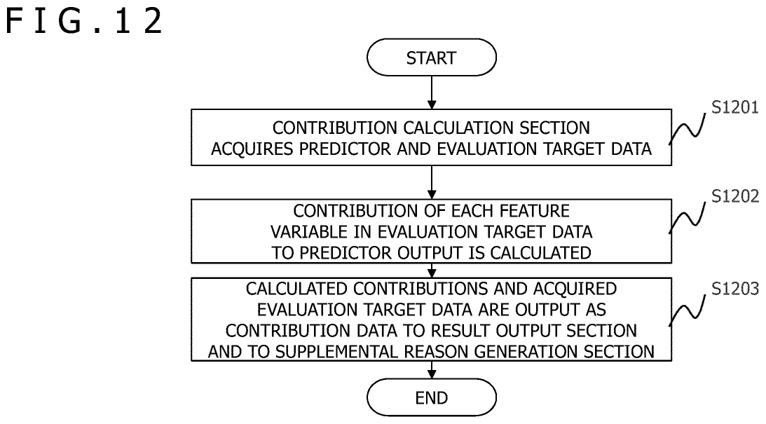

FIG. 12 is a flowchart depicting a flow of processing performed by the contribution calculation section 200 on the evaluation target data 900. In step S1201, the contribution calculation section 200 acquires the predictor 500 and the evaluation target data 900. In step S1202, the contribution calculation section 200 calculates the contribution of each feature variable in the evaluation target data 900 to the output of the predictor 500. The process may be carried out in a manner similar to calculating the data to be stored into the case data contribution storage section 400. In step S1203, the calculated contributions and the acquired evaluation target data are output as contribution data 1100 to the result output section 800 and to the supplemental reason generation section 700.

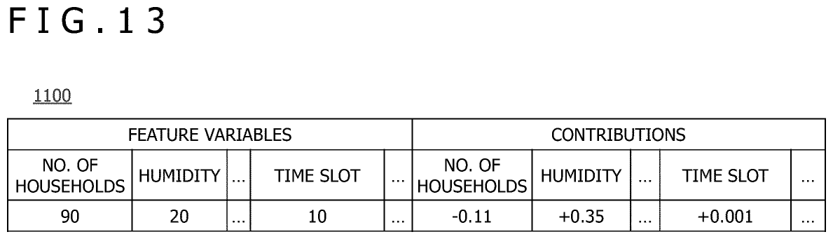

FIG. 13 is a tabular view listing an example of the contribution data 1100. This tabular view is interpreted in a manner similar to interpreting FIG. 7. With LIME or SHAP, if a change in a particular explanatory variable (feature variable) leads to the resulting output of AI being inverted or significantly varied, that item is estimated to have a high contribution to the result. With LIME or SHAP, however, XAI may present an explanation incongruous with the findings in the field in a case, for example, where the machine learning model is trained with emphasis on a feature variable with a high correlation to the feature variable that should inherently be considered important.

For example, suppose that the predictor 500 furnished with a model for predicting the incidence of burglary outputs the prediction result data 1000 illustrated in FIG. 11 and that the contribution calculation section 200 outputs the contribution data 1100 in FIG. 13. In this example, the sum of the contributions in FIG. 13 amounts to the predicted value of 0.9 in FIG. 11. Given the data, the prediction model predicts the probability of burglary incidence to be 0.9 (90%) with the explanation that “the humidity of 20% raises the probability of burglary incidence by 0.35 (35%).” However, this explanation is difficult to understand for users in the field unfamiliar with the knowledge of AI, such as local government staff members and police officers.

The reason for the above decision making is hard to understand unless supplemented with an explanation taking false correlation and confounding factors into consideration, such as “humidity is low in the daytime; people are often not at home in the daytime; thus burglary tends to occur.”

In the present embodiment, when presented with the contribution of an apparently irrelevant feature variable as the reason for decision making by the model, personnel in the field unfamiliar with AI technology are concomitantly given supplemental information for helping to interpretation and understanding of the reason for the decision made. For example, the embodiment extracts the finding “time slot is the daytime” as another factor affecting in common the two factors “humidity is low” and “burglary occurs,” and presents the additional factor to the personnel.

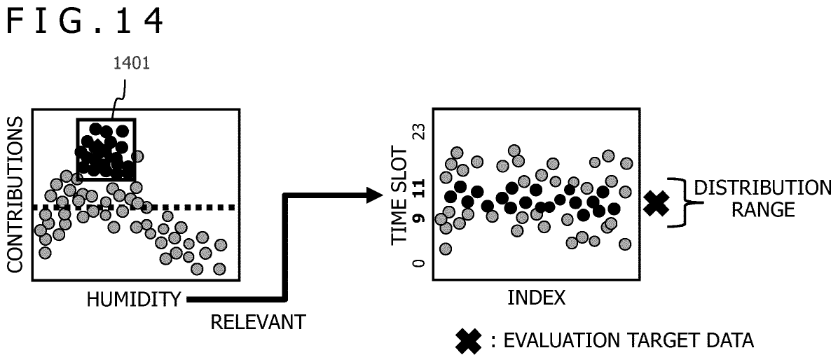

Explained below with reference to the conceptual diagram of FIG. 14 is a specific example of the above-mentioned incidence of burglary with a view to enable better understanding of the embodiment.

In the zero-th step, “humidity” and its contribution “+35%” are extracted as the feature variables that contribute most to the reason for decision making with the evaluation target data 900.

In the first step, from the information in the case data contribution storage section 400, pieces of peripheral data regarding the feature variables “humidity=20% and contribution=+35%” are acquired, and their indexes are extracted. In the present specification, the acquired peripheral data may be referred to as “proximate data group” for reasons of descriptive convenience. An index refers to a data ID that uniquely identifies a group of data in the training data. A peripheral plot 1401 is selected from a relation diagram involving the variables “humidity” and “contribution” that are apparently irrelevant to each other.

In the second step, from the information in the inter-feature-variable relevance storage section 300, a feature variable “time slot” highly relevant to “humidity” is selected.

In the third step, with emphasis on the values of “time slot” in the information in the case data contribution storage section 400, an evaluation is made as to whether there is a significant difference between the range where the data with the extracted index (proximate data group) is distributed (called the distribution range hereunder) on one hand and the range where all the other pieces of data are distributed on the other hand.

In the case where there is a significant difference and where the values of “time slot” in explanation target data are included in the distribution range, the distribution range is presented concomitantly as the information supplementing the initially presented reason based on “humidity.” This example thus reveals that the data indicative of a high contribution around the humidity of 20% is concentrated in the time slot of 9 to 11. From this, the contribution of “humidity” is found to also include the contribution of “time slot” being “9 to 11” to the predicted value.

A specific example of the information processing system for implementing the above processing is explained below.

### <Supplemental Reason Generation Section>

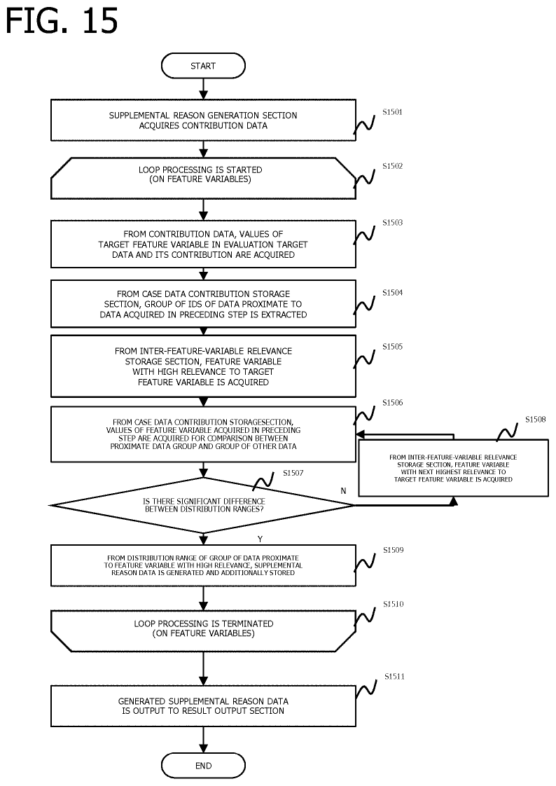

FIG. 15 is a flowchart depicting a flow of processing performed by the supplemental reason generation section 700. The process agent is the supplemental reason generation section 700.

In step S1501, the supplemental reason generation section 700 acquires the contribution data 1100.

In step S1502, loop processing is started on the feature variables in the evaluation target data 900.

In step S1503, the value of a target feature variable in the evaluation target data 900 and its contribution are acquired from the contribution data 1100. The loop processing may be performed on all feature variables as depicted in FIG. 15, or solely on the feature variables whose contributions are equal to or higher than a predetermined threshold value. Alternatively, the loop processing may be omitted, and only the feature variable with the highest contribution may be processed. As another alternative, the user may select the target feature variables.

In step S1504, from the case data contribution storage section 400, one or more indexes having data proximate to the group of the feature variable and contribution acquired in step S1503 are extracted. The extracted case data constitutes the proximate data group. Whether given case data is proximate or not may be determined by verifying whether the feature variable and the contribution fall within their respective predetermined ranges, for example.

In step S1505, from the inter-feature-variable relevance storage section 300, a feature variable highly relevant to the target feature variable is acquired.

In step S1506, the value of the feature variable obtained in step S1505 is acquired from the case data contribution storage section 400 for comparison between the distribution range of the proximate data group and that of the other data. Known statistical techniques may be adopted as the algorithm for making the comparison.

In step S1507, it is determined whether there is a significant difference between the distribution ranges. How much is significant as the difference may be suitably defined beforehand using known statistical techniques.

In the case where the difference is not significant, step S1508 is reached. In step S1508, a feature variable with the next highest relevance to the target feature variable is acquired from the inter-feature-variable relevance storage section 300 for use as the target feature variable. Steps S1506 and S1507 are then repeated.

In the case where the difference is significant, step S1509 is reached. In step S1509, supplemental reason data 1200 is generated from the distribution range of the proximate data group of the highly relevant feature variable.

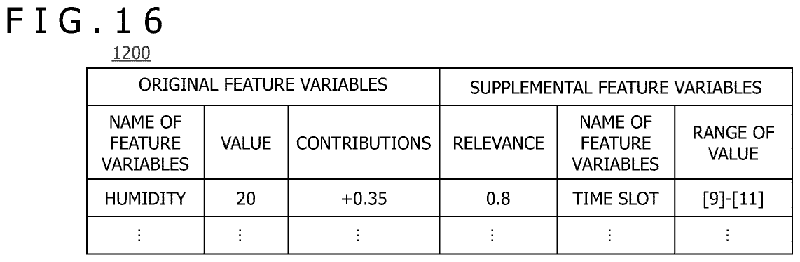

FIG. 16 is a tabular view listing an example of the supplemental reason data 1200. In this example, the pieces of data “humidity is 20% and its contribution is +35%” are indicated as the original feature variables (to be supplemented). It is also indicated that the data “range of values 9 to 11 as the time slot constituting the feature variable with a relevance of 0.8” represents a supplemental feature variable (for supplementing the humidity).

In step S1510, the loop processing is repeated on all feature variables. In some cases, the processing may be performed only on a portion of the feature variables as discussed above.

In step S1511, the generated supplemental reason data 1200 is output to the result output section 800.

### DISPLAY EXAMPLES

In response to a request from the terminal 2, for example, the result output section 800 generates output that causes the supplemental reason data 1200 to be transmitted to the terminal 2 for display on a display device thereof. In this embodiment, for example, the terminal 2 instructs the computer 1 to transmit the output to the terminal 2. What follows is an explanation of a graphical user interface (GUI) that can be used for the above purpose. The terminal 2 may be an ordinary personal computer or mobile terminal, with its display implemented by use of an ordinary browser, for example.

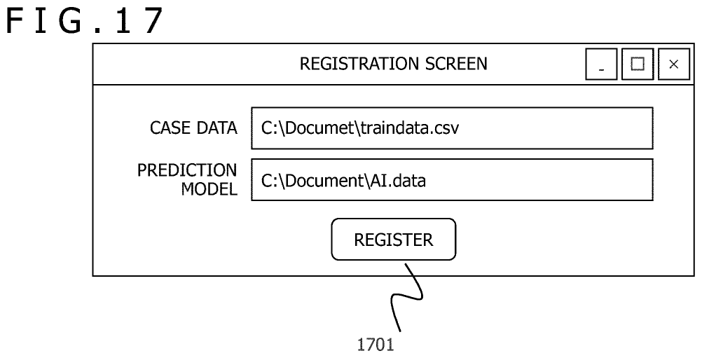

FIG. 17 depicts an example of the GUI for giving instructions on performance of the preparatory process indicated in FIG. 8. With the predictor 500 and the case data 600 designated, a register button 1701 is pressed. This causes the process in FIG. 8 to be executed and registrations to be made in the DBs of the inter-feature-variable relevance storage section 300 and the case data contribution storage section 400.

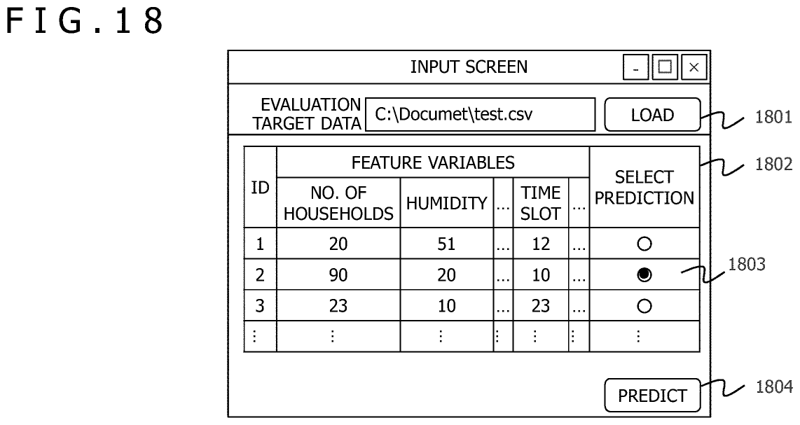

FIG. 18 depicts an example of an evaluation target data input screen as the GUI for designating the evaluation target data 900 and for instructing the predictor 500 to perform prediction. Here, a DB of evaluation target data including multiple entries is designated, and a load button 1801 is pressed to load the data. The loaded data is displayed in tabular form such as on a screen 1802. From the table, the prediction target data is designated using a select prediction button 1803. Then pressing a predict button 1804 causes the predictor 500 to execute the prediction.

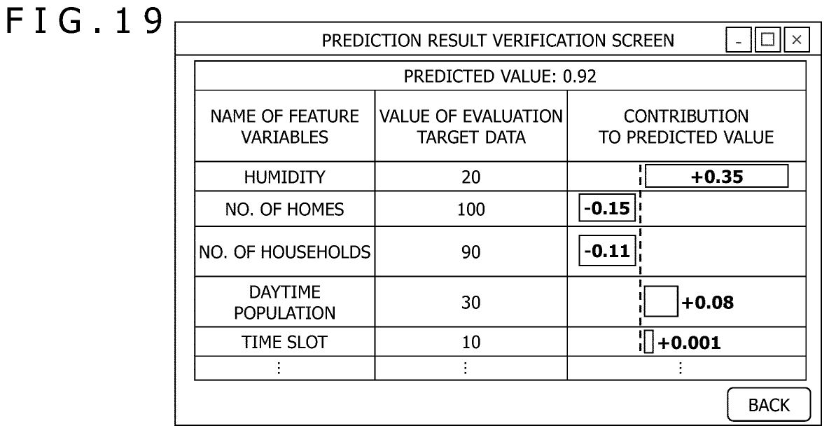

FIG. 19 illustrates an example of a prediction result verification screen as the GUI. The screen indicates the feature variables of the designated evaluation target data 900 (FIG. 10), the prediction result data 1000 (FIG. 11), and the contribution data with respect to predicted value (FIG. 13).

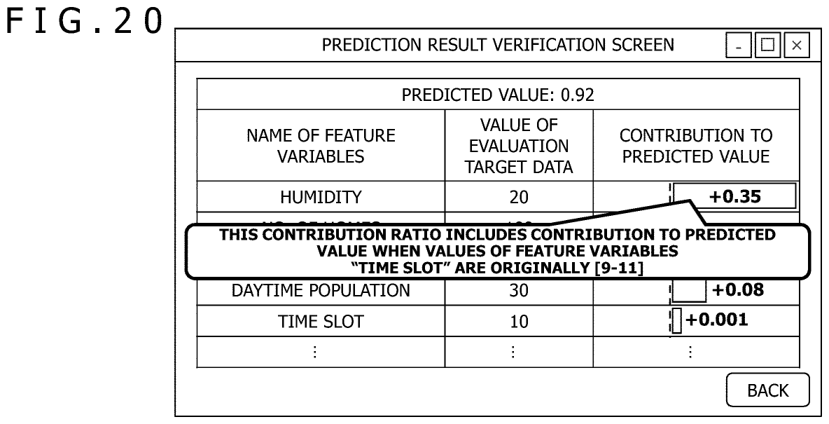

FIG. 20 illustrates an example of screen display indicating a supplemental reason. When a contribution to predicted value depicted in FIG. 19 is designated, the relevant supplemental reason is indicated. In this case, a supplemental reason “This distribution ratio includes the contribution to predicted value when the values of the feature variable ‘time slot’ are [9-11]” is indicated as the supplemental reason for the contribution of +0.35 of humidity, on the reason of the supplemental reason data 1200 (FIG. 16).

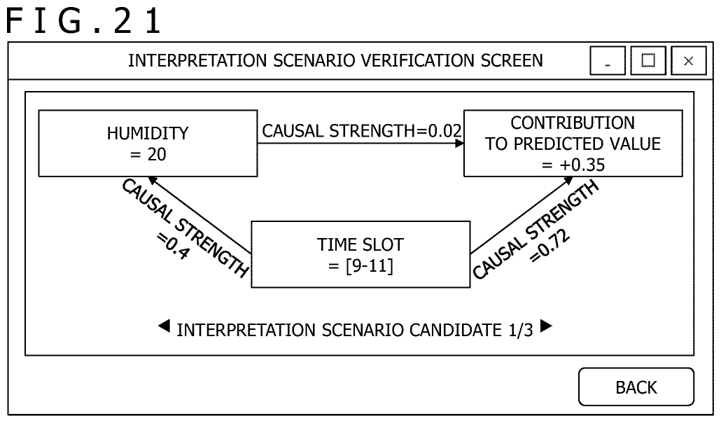

FIG. 21 is an illustration depicting an example of screen display indicating other supplemental bases. When a contribution to predicted value depicted in FIG. 19 is designated, the relevant supplemental reason is indicated. In this case, the display is switched to an interpretation scenario verification screen. The causal strength of humidity with respect to the contribution, the causal strength of time slot with respect to humidity, and the causal strength of time slot with respect to the predicted value are displayed as the supplemental reason for the contribution of +0.35 of humidity. This makes it possible to determine that the causal strength of time slot with respect to the predicted value is high. The techniques disclosed in Shohei Shimizu, et. al, “A Linear Non-Gaussian Acyclic Model for Causal Discovery,” Journal of Machine Learning Research 7 (2006) 2003-2030, for example, may be used as the method for calculating each of the causal strengths.

The embodiment described above thus provides an XAI technology by which the value of a first variable largely contributing to a prediction result and its contribution are estimated; a group of data proximate to the estimated value is extracted from training data; a second variable different from (but relevant to) the first variable is identified; and a comparison is made between the proximate data group and the group of other data that is of a value of the second variable to easily ensure consistency with the findings in the field.

### Second Embodiment

In the processing flow of the first embodiment in FIG. 15, the system determines in steps S1506 and S1507 whether there is a significant difference between the distribution range of the proximate data group and that of the other data upon comparison therebetween.

In an alternative method, a graph such as one depicted on the right side of FIG. 14 may be presented directly to the user as the supplemental reason data, prompting the user to visually determine whether there is a significant difference between the distribution ranges. In this case, steps S1506 and S1507 are omitted, and the display may be arranged to let the proximate data group be identified in a graph indicative of the relation between the target feature variable and the indexes. In the case where the proximate data group is concentrated in a specific range of the target feature variable as depicted in FIG. 14, that range may be determined to be significant.

### Third Embodiment

The first embodiment depicted in FIG. 9 provides an example in which the supplemental reason data 1200 is always added when the predictor 500 is caused to perform prediction. Alternatively, the supplemental reason data may not be generated automatically every time. Instead, the user may be prompted to designate the contribution of a specific feature variable regarding which the supplemental information is to be generated. The designation may be used as a trigger to activate the supplemental reason generation section 700. For example, in the case where the user is presented with the prediction result in FIG. 19 and where the user, in a response, is not convinced of the contribution of humidity, the response is used as a trigger for the supplemental reason generation section 700 to generate the supplemental reason data 1200.

When the supplemental reason data is generated not exhaustively but on demand, the cost of the processing can be reduced.

### Fourth Embodiment

Explained below as another example of reducing the processing cost is one in which the feature variable for which the supplemental reason data is generated is automatically selected. In the loop processing of the first embodiment in FIG. 15, all feature variables are basically targeted to be processed.

In that case, a specific feature variable may be selected as the target feature variable on the reason of the strength of its causal relation with the objective variable as evaluated by known techniques of search for causal relation. This helps reducing the processing cost with regard to the variables with no need for supplements.

For example, in order to find a noteworthy variable such as humidity, the strength of direct causal relation with the objective variable is measured by causal inference. The loop processing in FIG. 15 is then performed on the variables of which the strength of causal relation is smaller than a predetermined threshold value but of which the contribution is higher than a predetermined threshold value.

### Fifth Embodiment

What follows is an explanation of another example of the method of searching for the proximate data group in a peculiar distribution. In reference to FIGS. 14 and 15 for the first embodiment, it has been explained that the proximity range of the proximate data group is defined beforehand, to be ±5%, for example. Alternatively, the user may be prompted to designate, through the GUI, for example, a specific range as the proximity range so as to define a more meaningful proximity range for the variable having a peculiar distribution. For that purpose, the user need only be presented with the graph such as one on the left side of FIG. 14, for example, so that the user can designate the range of the peripheral plot 1401.

### Sixth Embodiment

It has been explained that the relevance calculation section 100 of the first embodiment calculates the correlation coefficient between feature variables and stores the calculated coefficients into the inter-feature-variable relevance storage section 300 in the form of a DB. However, given that the correlation coefficients are useful solely for evaluating the linear strength of relevance, for example, the relevance calculation section 100 may calculate a regression formula, evaluate the degrees of fit (level of error) with the regression formula, as the degree of relevance, and store the evaluated degrees of relevance into the inter-feature-variable relevance storage section 300.

Alternatively, the Maximum Information Coefficient (MIC) supporting nonlinear relevance or the causal strength explained in Shohei Shimizu, et. al, “A Linear Non-Gaussian Acyclic Model for Causal Discovery,” Journal of Machine Learning Research 7 (2006) 2003-2030) may be adopted in representing the relevance between the variables.

### Seventh Embodiment

Explained above in connection with the first embodiment is the example in which the supplemental reason data is generated and displayed for a single target feature variable (e.g., humidity). Alternatively, the processing may be expanded in such a manner that, in search of supplemental information, the information may be generated using not only one but also multiple variables.

In the example of “humidity” for the first embodiment, the processing in FIG. 14 reveals the supplemental reason data 1200 of FIG. 16 in which “time slot” is [9-11]. Here, if the graph of relation on the right side in FIG. 14 between the indexes and the time slots is generated by month, it can be recognized that the proximate data group is concentrated in the range where “Month” is [7-8] and where “time slot” is [9-11]. This prompts the interpretation that the cases of low humidity increasing the risk of burglary incidence are concentrated in the day time slots in summer.

Likewise, if the graph of relation on the right side in FIG. 14 between the indexes and the time slots is generated by daytime population, it is possible to prompt the interpretation that the cases of low humidity increasing the risk of burglary incidence are concentrated in the time slot of [9-11] on the daytime population of [0-20], i.e., in the daytime when people tend to go out.

In this manner, more detailed studies are made possible by generating the supplemental reason data with use of the relations between multiple feature variables.

According to the above-described embodiments, given the contribution of a feature variable presented as the reason for decision making, the values of explanation target data and the contributions of their variables are matched against a group of contribution vectors with respect to previously stored training data. From the characteristics of a range of values that can be taken by another highly relevant feature variable on the reason of the result of the matching, supplemental information is generated regarding the reason for the decision made with an apparently irrelevant feature variable.

According to S. M. Lundberg and S. Lee, “A Unified Approach to Interpreting Model Predictions, NIPS 2017”, the variables strongly correlated to each other are grouped by similarity. From the grouped variables, representative variables are extracted for factor analysis. This resolves the problem of multiple similar feature variables being output in the result of contribution analysis. This method, however, cannot be used when applied to XAI unless the model itself is altered. Further, useful feature variables may be neglected for the ease of understanding the reason, which can worsen the accuracy of the model.

According to the configurations of the above-described embodiments, it is possible to find a feature variable that should be considered inherently important but of which the ratio of direct contribution is underestimated and to present the found feature variable as the supplemental information regarding the feature variable overestimated in the result of the decision made by the prediction model. As a result, on the screen presenting the contribution of each feature variable to model-based decision making, it is possible to display the characteristics of another strongly relevant feature variable as the supplemental information regarding the contribution of a specific feature variable.

What is claimed is:

1. An information processing system comprising:
a predictor;
a contribution calculation section; and
a supplemental reason generation section,
the system being capable of accessing a feature variable relevance storage database that stores relevance between feature variables in case data and a case data contribution storage database that stores a contribution of a feature variable in the case data to a result of prediction by the predictor,
wherein the contribution calculation section inputs the predictor and evaluation target data as input to the predictor, calculates the contribution of each of the feature variables in the evaluation target data to output of the predictor, and outputs the calculated contributions and the acquired evaluation target data as contribution data, and
the supplemental reason generation section inputs the contribution data, extracts a group of data proximate to a value and a contribution of a first feature variable from the case data contribution storage database, identifies a second feature variable relevant to the first feature variable from the feature variable relevance storage database, generates supplemental reason data based on a distribution of the proximate data group within a distribution of the second feature variable by use of the data in the case data contribution storage database, and outputs the generated supplemental reason data.

2. The information processing system according to claim 1, wherein, given the contribution data, the supplemental reason generation section successively selects each of all included feature variables as the first feature variable through loop processing.

3. The information processing system according to claim 1, wherein, given the contribution data, the supplemental reason generation section selects, as the first feature variable, the feature variable of which the contribution is equal to or higher than a predetermined threshold value.

4. The information processing system according to claim 1, wherein, given the contribution data, the supplemental reason generation section selects, as the first feature variable, the feature variable designated by a user.

5. The information processing system according to claim 1, wherein, given the contribution data, the supplemental reason generation section selects the first feature variable on a reason of strength of causal relation to the output of the predictor as evaluated by a causal search method.

6. The information processing system according to claim 1, wherein the case data is either training data used to train the predictor in supervised learning or data of which statistical properties are similar to those of the training data.

7. The information processing system according to claim 1, wherein, upon extracting the proximate data group, the supplemental reason generation section allows a user to designate a range of the proximate data group.

8. The information processing system according to claim 1, wherein the supplemental reason data is data for graphically displaying the distribution of the proximate data group within the distribution of the second feature variable.

9. The information processing system according to claim 1, wherein the supplemental reason data is data for numerically indicating a range in which the proximate data group within the distribution of the second feature variable is concentrated.

10. The information processing system according to claim 1, wherein the supplemental reason data includes information based on a relation between the distribution of the second feature variable and a third feature variable.

11. An information processing method for generating supplemental information regarding a result of prediction output by a predictor upon receiving input of evaluation target data, the predictor having been trained by use of training data, the information processing method using a feature variable relevance storage database that stores relevance between feature variables in the training data and a case data contribution storage database that stores a contribution of a feature variable in the training data to the result of prediction by the predictor, the method comprising:
a first step of extracting a group of data proximate to a value and the contribution of a first feature variable from the case data contribution storage database;
a second step of identifying a second feature variable relevant to the first feature variable from the feature variable relevance storage database; and
a third step of generating information based on a distribution of the proximate data group within a distribution of the second feature variable by use of the data in the case data contribution storage database.

12. The information processing method according to claim 11, wherein, in the first step, the value and the contribution of the first feature variable are values regarding the evaluation target data.

13. The information processing method according to claim 12, wherein the third step further includes
a distribution comparison process of making a comparison between the distribution of the proximate data group within the distribution of the second feature variable on one hand and the distribution of other data on the other hand; and
a supplemental explanation process of generating supplemental reason data based on a result of the comparison performed in the distribution comparison process.

14. The information processing method according to claim 13, wherein, in a case where there is a significant difference between the distribution of the proximate data group and the distribution of the other data, the supplemental reason data includes information for identifying the second feature variable and information explanatory of the distribution of the proximate data group within the distribution of the second feature variable.

15. The information processing method according to claim 14, the supplemental reason data is displayed in association with the value and the distribution ratio of the first feature variable.
